(19) United States
(12) Patent Application Publication
(10) Pub. No.: US 2006/0224431 A1
(43) Pub. Date: Oct. 5, 2006

(54) Data processing method, system and computer program

(76) Inventors: Hans-Ulrich von Helmolt, Heidelberg (DE); Michael Picht, Walldorf (DE); Volker Jaeck, Nussloch (DE); Juergen Seeburger, Wiesloch (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/569,761

(22) PCT Filed: Aug. 20, 2004
(86) PCT No.: PCT/EP04/09348

§ 371 Date: Feb. 24, 2006

(30) Foreign Application Priority Data
Aug. 27, 2003 (EP) 03 019 349.4

(51) Int. Cl. G06Q 99/00; G06F 15/02

(52) U.S. Cl. 705/9; 705/1

(57) ABSTRACT

A system, method and computer program product are disclosed for data processing in a supply chain management utilizing a central data processing system which integrates a plurality of functionalities for partner and system determination, as well as availability checking. Upon receiving a request which includes a plurality of items from a customer, unique identifiers are generated and assigned relevant to the customer's items in response to the request. Each request is split into plurality of sub-requests where each sub-request is assigned to an internal or external system by means of the rules. In case a synchronous communication is used the dynamic combining of the sub-results is performed at runtime. In case an asynchronous communication is employed, the sub-responses are aggregated in a database until all sub-responses have been received. The amount of requested resources is adjusted in both cases based on the information received from the central data processing system.

### FIELD OF THE INVENTION

The present invention relates in general to a data processing system and, in particular, to a supply chain management system and method.

### BACKGROUND AND PRIOR ART

The modern logistic network of the business relationships has evolved into increasingly complex multi-partner and multi-system environment shaped by dynamic events. Supply chain management is getting more unpredictable for example due to outsourcing or globalization. The determination of a partner in the modern supply chain is usually done by functionalities located in vast array of systems: for example, planning systems, purchasing systems, and transportation systems. Many of these systems are often legacy systems. Thus, the coordination of processes inside the logistic network needs to be responsive, adaptive and open to integrate partners.

U.S. Pat. No. 6,591,243 (Grettve et al.) discloses a method and system for improved supply chain management where detailed description of the prior art logistic systems and the related prior art problems are included.

One of the considerable problems plaguing Supply Chain Management is the lack of timely communication between the different partners and systems in the supply chain what in turn results in higher costs, inadequate resources or even waste. Also, the lack of possibility to quickly and effectively determine at run time which partners or systems are available adds to the problem. Therefore, there is a need for central data processing system that would be flexible and able to react to different business scenarios.

### SUMMARY OF THE INVENTION

According to various embodiments of the central data processing system disclosed herein, a method which integrates a plurality of functionalities for partner and system determination, as well as availability checking is described. The central data processing system includes hardware, software and communications components that cooperatively achieve the technical effect of an improved, centralized data processing in a supply chain management. A customer request containing plurality of items is received from a corresponding customer of a supply chain. Item unique identifiers are generated and assigned to the items. Then, a plurality of sub-requests is generated where each sub-request is assigned to a system by means of the rules.

The sub-requests carrying separate unique identifiers are processed at the partner side and sub-responses are received at the central data processing system. Responses are generated based on association of sub-responses with the same original item and then, send back to the customers data processing system. In case the synchronous communication is used the dynamic combining of the sub-results is performed at runtime. In case asynchronous communication is employed, the sub-responses are aggregated in a database until all sub-responses have been received. The amount of requested resources is adjusted in both cases based on the information received from the central data processing system.

The present invention makes possible to easily plug in the existing functionalities into the one central data processing system which could provide flexible and adaptable partner and system determination, as well as, availability checks in a supply chain management. It also enables faster and more effective execution and control of logistic processes in a complex partner/system environment. It also provides an interface that allows a customer to deal with one system and avoid the complexity of multiple systems and functions.

In another aspect, the present invention relates to a data processing system for processing a request. Typically, the request comprises a number of request items. For example, the request can be a costumer query regarding the availability and delivery conditions for the items as listed in the request. The data processing system is coupled to a number of partner computer systems. The data processing system selects an asynchronous or a synchronous communication mode for communication with the partner computer systems in order to process the request. The determination whether asynchronous or synchronous communication is to be selected can be made using a set of rules that are applied on the request. This rulebase can also be used in order to split the request into a set of sub-requests where each sub-request is assigned to one of the partner computer systems. If the synchronous communication mode has been selected with respect to one of the partner computer systems the sub-requests are sent sequentially from the data processing system to the respective partner computer systems. In other words, a consecutive sub-request is only sent from the data processing system to one of the partner computer systems if a response to a previous sub-request has been received by the data processing system. The sub-responses of the partner computer systems are held in the main memory of the data processing system, i.e. a random access memory. After all sub-responses have been received, the sub-responses are combined into a consolidated response that is sent back to the requester, e.g. the sales system.

If the asynchronous communication mode has been selected some or all of the sub-requests can be sent in parallel to the respective partner computer systems. Each time a sub-response is received from the partner computer systems, the status of a database is checked. The database is stored on a non-volatile storage device, such as a magnetic disc. If the status of the database indicates that all sub-responses except the newly received sub-response are already present in the database, the sub-responses are read out from the database and are combined into a consolidated response which is then sent back to the requestor.

For example, a unique identifier, such as a globally unique identifier (GUID), is assigned to the sub-requests. The sub-request that is sent to a partner computer system carries its unique identifier. The sub-response received from the partner computer system in response to the respective sub-request carries the same unique identifier. The unique identifiers are used as database keys for storing the sub-responses in the database and for determining the status of the database by querying the database by means of the unique identifiers.

The present invention is particularly advantageous as it enables the data processing system to communicate both in an asynchronous or a synchronous communication mode with the partner computer systems that are coupled to the central data processing system. The synchronous communication mode has the advantage that a response can be provided to the requestor with a minimal latency time, as no storage operations on the non-volatile storage device and no database queries are required as the respective information is held in the random access memory. However, the synchronous communication mode does not allow to send a number of the sub-requests in parallel to the partner computer systems. As parallelization of the processing is not possible this results in relatively long idle times for the data processing system where the data processing system is in a wait state in order to wait for a sub-response until the next sub-request can be sent out to the respective partner computer system.

The asynchronous communication mode has the advantage that a number of sub-requests can be sent out in parallel to the partner computer systems. Because of the storage of the sub-responses in the database and the query operations that are required in order to determine whether all sub-responses have already been received a longer latency time is typically experienced in the asynchronous communication mode for providing the response. However, the parallelization of the processing substantially reduces the idle times of the central data processing system and thus enables to maximize the overall system throughput in order to make maximum usage of the available hardware resources.

It is thus possible to select the synchronous or asynchronous communication modes depending on the requestor's preferences which can be given in the request and/or depending on the partner computer system's communication capabilities. For example, some of the partner computer systems are capable to communicate in only one of the asynchronous or synchronous communication modes whereas other partner computer systems have the capability to communicate both in the asynchronous and synchronous communication modes. These capabilities of the partner computer systems and/or user preferences can be stored as rules in the central data processing system for selecting the asynchronous or synchronous communication modes.

In particular the present invention can be used for a fulfillment coordination engine as described in PCT Patent Application WO 03/075195 A2 which is herein incorporated by reference in its entirety.

### BRIEF DESCRIPTION OF THE DRAWINGS

FIG. 1 illustrates a central data processing system for processing of the customer request of the present invention.

FIG. 2 is a flowchart of a process describing a method of the present invention.

FIG. 3A illustrates structure of the document used in a central data processing system and mapping of the data from standard orders.

FIG. 3B illustrates the case when base documents used in a central data processing system create document hierarchies.

FIG. 4 is a block diagram of a more detailed embodiment of the central data processing system of the present invention where synchronous communication is used.

FIG. 5 is a block diagram of a more detailed embodiment of the central data processing system of the present invention where asynchronous communication is used.

FIG. 6 is a block diagram of a further preferred embodiment of a data processing system of the invention,

FIG. 7 is a flow diagram illustrating a preferred mode of operation of the data processing system of FIG. 6.

### DETAILED DESCRIPTION

The claimed invention is applicable to many different industries. One skilled in the art will appreciate that the various embodiments and concepts of the present invention are applicable to plurality of industries without straying from the spirit of the present invention.

The present invention includes a supply chain management system involving at least one customer. Supply chain also includes at least one partner. The supply chain partners include business partners, locations and logical systems.

Exchange Infrastructure (XI) can be used for various embodiments of the present invention. It enables the development of the cross-system applications that exchange a multitude of system messages using the runtime infrastructure and synchronous or asynchronous communication. However, since the use of synchronous communication via the XI currently requires that the called function works without state, the partner ascertainment service can only be called synchronously via the XI if the application scenario does not require that the partner ascertainment service or any of the partner ascertainment functions it calls work with state.

The aim of the Exchange Infrastructure is to integrate different systems implemented on different platforms (Java, ABAP, and so on). The Exchange Infrastructure is based on an open architecture, makes uses of open standards, in particular those from the XML (eXtensible Markup Language) and Java environments; and offers services that are essential in a heterogeneous and complex system landscape: namely a runtime infrastructure for message exchange; configuration options for managing business processes and message flow; and options for transforming message contents between the sender and receiver systems.

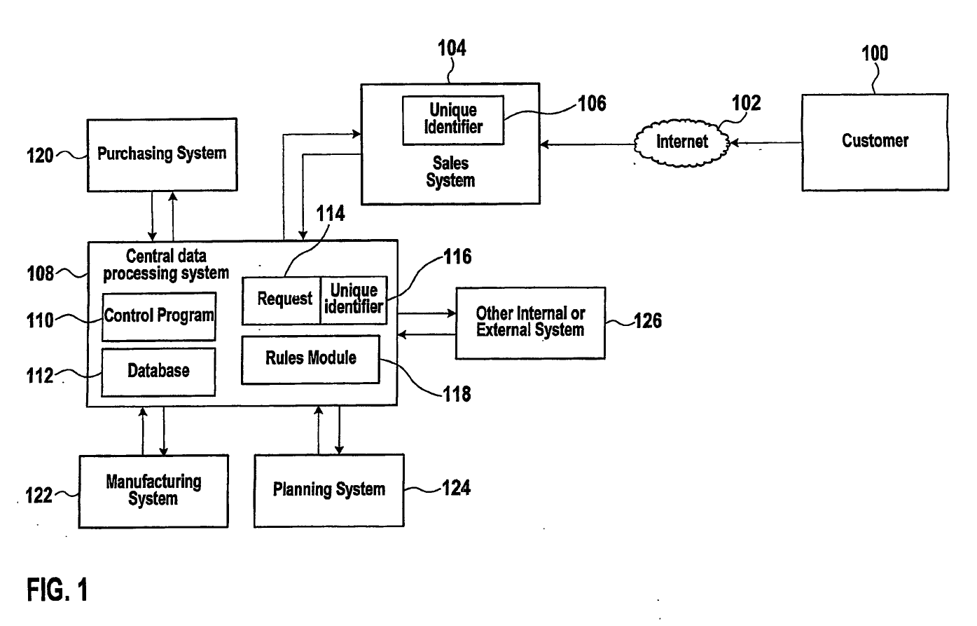

FIG. 1 illustrates a central data processing system 108 for processing of a customer request 114 according to an embodiment of the present invention. Sales system 104 provides electronic connectivity to the central data processing system and enables collection of customer requests for future processing. Utilizing a network, for example an Internet 102, a request for at least one item is received from a corresponding customer 100 at the central data processing system.

Subsequently, a central data processing system checks if each item has a unique identifier 106; if an item is found without a unique identifier, a new unique identifier 116 is generated and assigned to this item. Customer requests comprising a plurality of items are then processed by means of a set of rules 118 in a looping mode, that is when the request has more then one item then each item is sequentially processed and the response is send for each item.

The control program 110 implements the corresponding control processes. The assigned unique identifiers are then stored in a database 112. When partner systems such as for example a purchasing system 120, a manufacturing system 122, a planning system 124 or any other internal or external systems 126 send their responses back, those responses are associated in turn with the original items and the final response is then sent to the customer's data processing system.

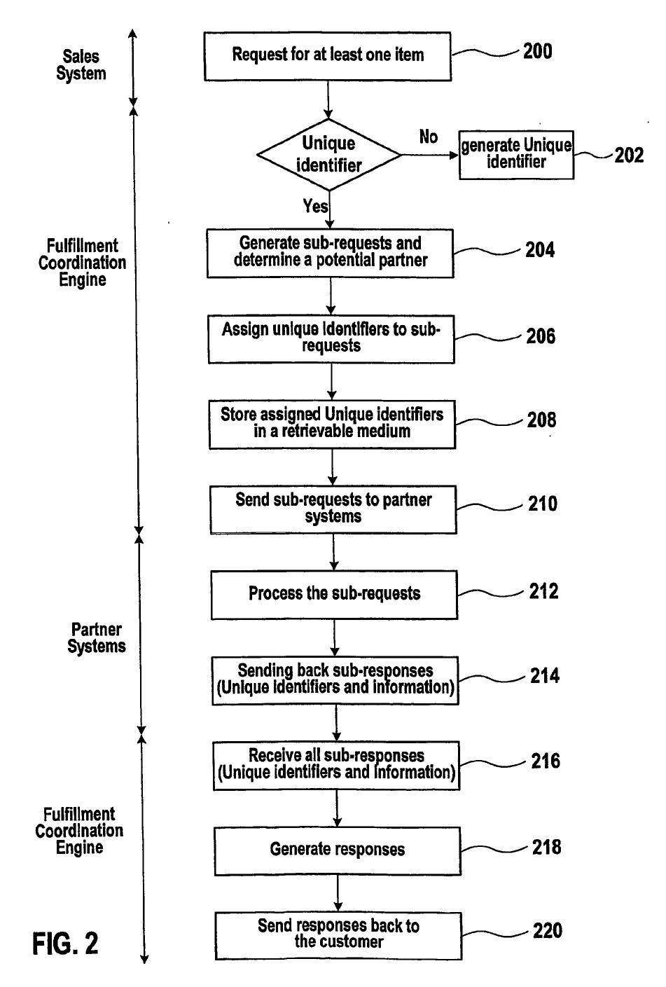

FIG. 2 depicts a corresponding flow chart. In the step 200 a request for at least one item is sent by the customer's data processing system, in this case a Sales system. When request is received in a central data processing system, in this case a Fulfilment Coordination Engine (FCE), in the step 202 each item is checked for presence of the unique identifier; if the unique identifier is missing the FCE generates and assigns unique identifiers to the item. Then, in the step 204, the sub-requests are generated and assigned to a partner's system by means of the rules.

In the next step 206 each of the sub-requests receives a separate unique identifier and assigned unique identifiers are stored in the retrievable medium in the step 208. That means that in case of asynchronous communication, the unique identifiers are stored in the database. However, in the case of synchronous communication the unique identifiers are stored in the memory and they are only in this case stored in the database when the Logical Unit of Work (LUW) in the called system is ended with the command COMMIT. In the step 210 sub-requests are sent to partner systems.

At the partner system side steps 212 and 214 are performed. First, all the requests are processed and then sub-responses including unique identifiers and information are send back to the central data processing system. Fulfilment Coordination Engine, in the step 216, receives all sub-responses from the partner systems and in the step 218, the responses are generated based on association of sub-responses with the original item. In the final step 220, the responses are send back to the customer's data processing system, in this case a sales system.

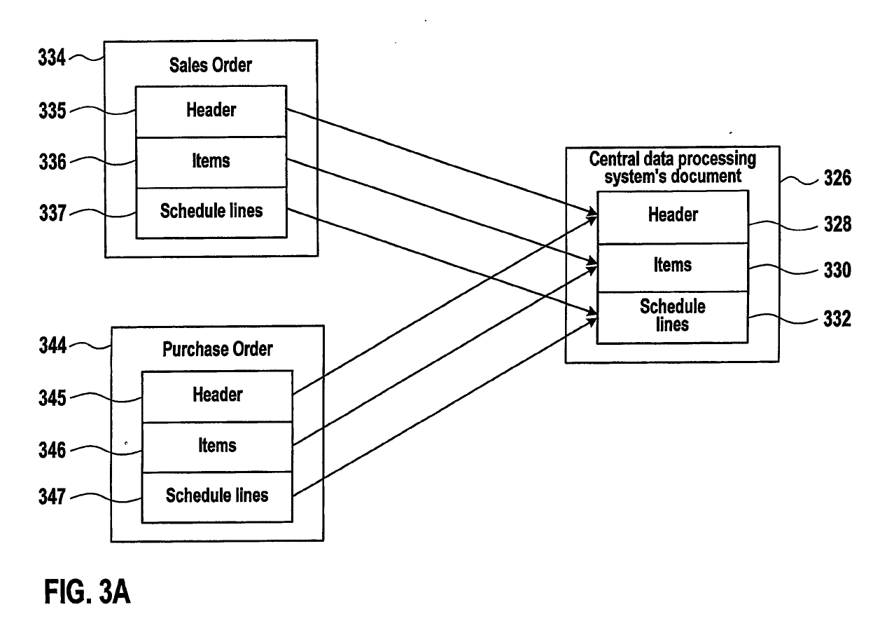

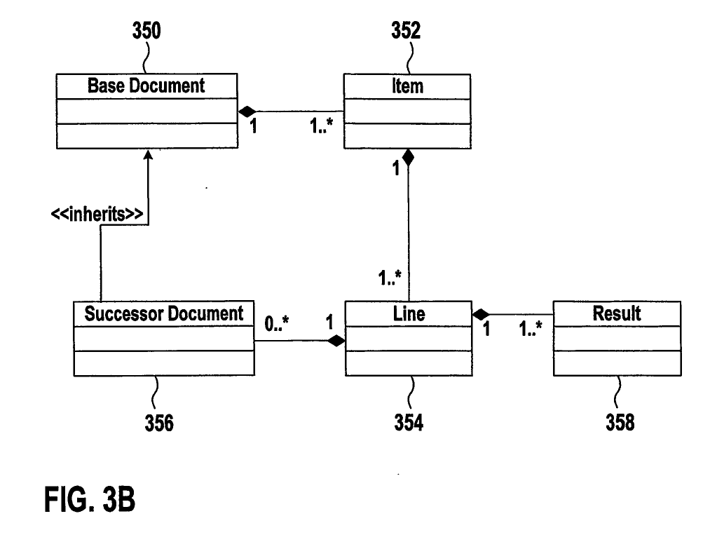

FIG. 3A illustrates a structure of the document used in the central data processing system and associated mapping of the data from standard orders. Data processing conducted in multi-system and multi-business environment means that various document types can be used such as for example purchase orders or sales orders.

In order to be able to operate on the plurality of documents, central data processing system can for example use an order-like document structure 326 that consists of a header section 328, at least one item 330 that can contain for example fields like business partner, product, location or contract; and at least one schedule line 332 per item comprising information regarding a delivery date and a quantity. This special design of the three level structure allows all documents that exist in internal systems as well as all those documents of different applications that are relevant for central data processing to be mapped. If for example, sales order processing calls the central data processing system, then the data of the sales order 334 that was transferred to the central data processing system via the interface, is mapped onto the document 326.

The sales order header 335 is mapped on the document header 328, the order items 336 are mapped on the document items 330 and the request schedule lines 337 on the document schedule lines 332. The similar process takes place when the system receives a purchase order 344. The purchase order header 345 is mapped on the document header 328, the purchase order items 346 are mapped on the document items 330 and the purchase order schedule lines 347 on the document schedule lines 332.

FIG. 3B depicts, for example, the case when product substitution and/or location substitution occurs and base documents 350 create document hierarchies. For example in the result 358, schedule lines 354 have a list of successor items 352 which can include partners, substitution products or locations. Also, a schedule line 354 contains several successor documents 356. Beside product and/or location substitution also further hierarchy levels can be produced in the document.

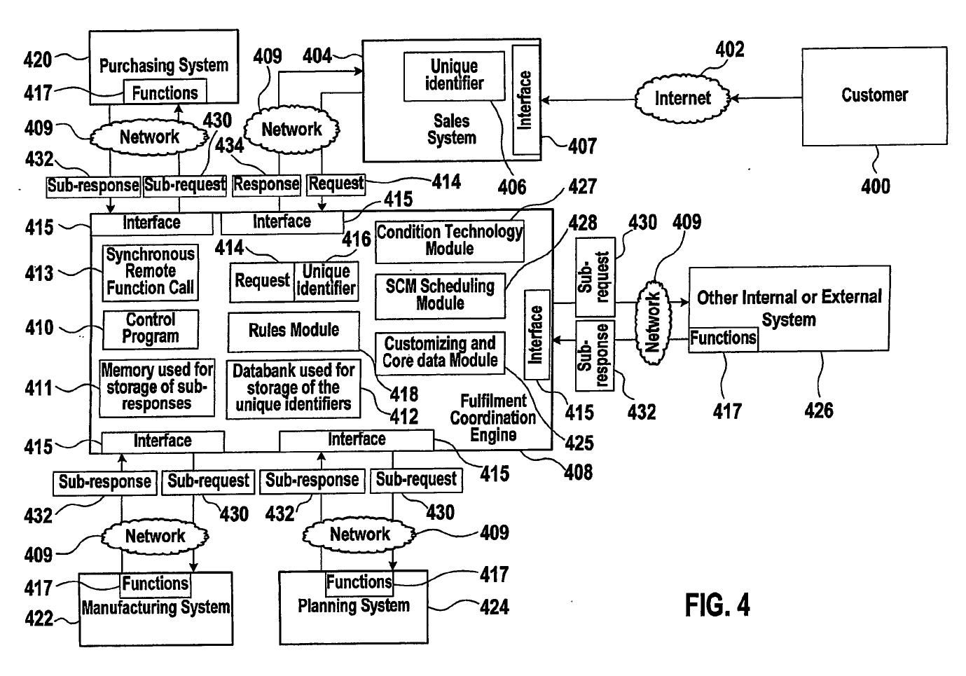

FIG. 4 illustrates a more detailed embodiment of the data processing system of the present invention, describing a case when synchronous communication is used throughout the supply chain. The embodiment of FIG. 4 constitutes a logical continuation of the FIG. 1 where like elements are referenced by like reference numbers having added 300. Synchronous communication takes place in this embodiment of the invention via Synchronous Remote Function Call (sRFC) 413 if any of the called partner functions work with state. Since the use of synchronous communication via the XI currently requires that the called function works without state, the partner ascertainment service can only be called synchronously via the XI if the application scenario does not require that the partner ascertainment service or any of the partner's functions it calls work with state.

According with the preferred embodiment the central data processing system is in this case a Fulfilment Coordination Engine (FCE) 408. As shown in FIG. 4, FCE receives a request 414 for at least one item from a corresponding customer 400 via the Network 409 which can also include Internet 402. In this case a calling application is a Sales system 404. Subsequently, each item is checked for the presence of a unique identifier 406, if an item is found without a unique identifier, a new unique identifier 416 is generated and assigned to this item. The control program 410 is the central component of the Fulfilment Coordination Engine.

The control program must be called to begin the request processing. The set of rules 418 determined by the control program contains a sort profile, a selection profile, a search key and the determination procedure. A sort profile is used to determine how partner lists should be sorted for further processing. A selection profile is used to define the procedure used to select partners. A search key and the determination procedure are used to determine whether an availability check is executed and if so, what kind. A plurality of sub-requests 430 for plurality of partners' systems is then generated where each sub-request is assigned to an internal or external system by means of the set of rules where complex dependencies have access using Condition Technology 427. In this case, the objects, for example rules searched for are determined by evaluating conditions. The search key is then interpreted as a condition type.

The Fulfilment Coordination Engine then calls synchronously functions 417 according to Customizing 425. When synchronous communication is used, the customer receives immediately a response also synchronously, so that customer's data processing system can continue working. In most cases, called functions are implemented in the external systems. Functions are not called directly but via corresponding interfaces 415. In contrast to functions, the interfaces are always implemented on the side of the central data processing system. The call of a function, and the respective mapping are implemented within an interface. There is a 1:1 relationship between interfaces and functions: There must be a separate interface for each of the functions. In contrast, an N: M relationship exists between interfaces and logical systems.

The assigned unique identifiers are then stored in a database 412 while sub-requests are sent to different partner systems. Sending of the sub-requests to partner systems such as for example a purchasing system 420, a manufacturing system 422, a planning system 424 or any other internal or external systems 426 further comprises either sending a request for a partner search or a partner availability check at schedule-line level or determining at least one business system or an availability check for this system at schedule-line level. It is further determined on the item level which availability check function should be called. A separate unique identifier for each of the sub-requests is then generated.

Availability check returns confirmation of dates and quantities as well as, if necessary, alternative products and/or locations are included. The availability check reserves temporary a requested resources that have been identified as available. The resources are reserved this way that the requested resources are equal to the original resources less the quantities that have already been confirmed and reserved via partner's system functions previously called. Thus, availability checks carried out in processes running in parallel do not consume the same quantities. It is assured that overbooking of resources does not occur during an availability check.

Some functions enable the assignment of an expiration date to their temporary quantity assignments. If this date has been reached, the temporary quantity assignments are automatically handled (deleted, for example). Up to this date, the temporary quantity assignments are active, that is, they reserve a quantity. However, if the expiration date is not assigned automatically, the Fulfilment Coordination Engine has to sent a specific message terminating the reservation of resources.

On the other hand, when partner search is executed, a list of partners is returned. Subject to the partner's functions used, further data such as prices and contracts, and similar, can be also included.

Supply Chain Management (SCM) scheduling module 428 can be called by the Fulfilment Coordination Engine to determine the dates which are transferred to the partners' functions based on the dates received from the customer. Also, it is further used to determine the dates to be returned to the customer based on the dates received in the sub-responses from the partners' systems.

When Fulfilment Coordination Engine receives the sub-responses 432, those resulting sub-responses which are sent by the partner systems back to the FCE have the same unique identifiers as the sub-requests sent originally. Thus, the sub-responses can be associated on the base of the matched unique identifiers with the original sub-requests. Those sub-responses are then stored in the main memory 411 of the Fulfilment Coordination Engine and the internal logic checks if all the roots of the unique identifiers are there so the final response 434 can be sent to the customer's data processing system immediately in order for it to continue working without interruptions. The response can be displayed utilizing a sales system interface 407. However, it is also possible that the result is not displayed at all, it depends on the calling system/application which of the two options occurs. In any case, all the details of the partner search or/and availability check are hidden from the calling system/application.

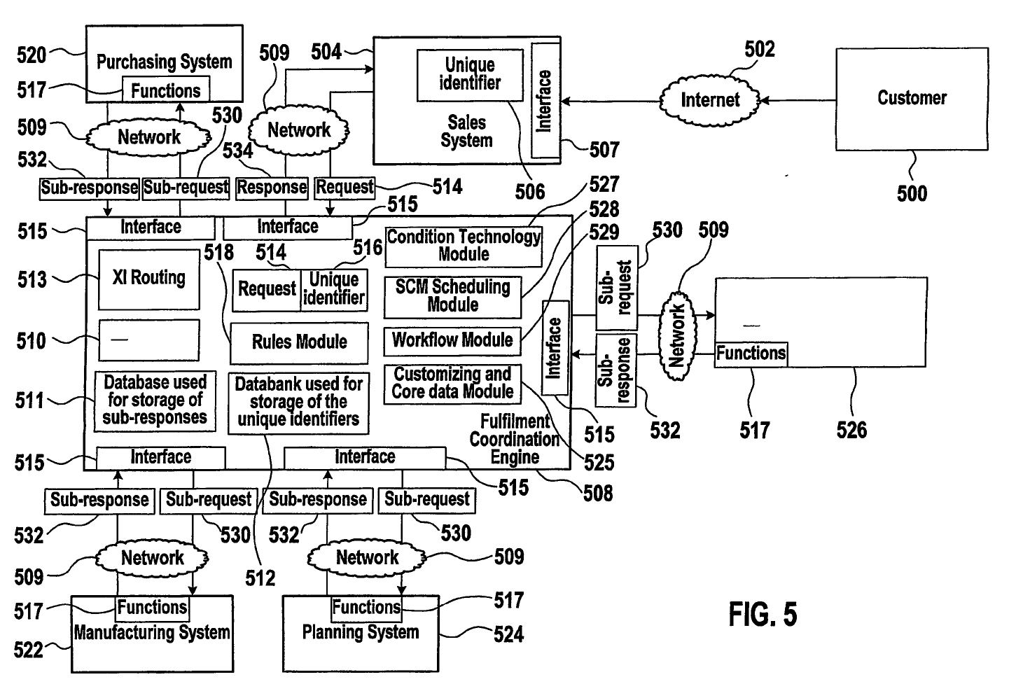

FIG. 5 illustrates a more detailed embodiment of the data processing system of the present invention, describing a case when an asynchronous communication is used throughout the supply chain. The embodiment of FIG. 5 constitutes a logical continuation of the FIG. 1 where like elements are referenced by like reference numbers having added 400.

According with the preferred embodiment the central data processing system is in this case a Fulfilment Coordination Engine (FCE) 508. In the case of the use of asynchronous communication the Fulfilment Coordination Engine is called asynchronously and it also calls asynchronously the functions located in the external partner systems (520, 522, 524, and 526) via the control program. Asynchronous communication takes place via the Exchange Infrastructure (XI) 513.

Thus, the Fulfilment Coordination Engine 508 receives asynchronously a request 514 for at least one item from a corresponding customer 500 via the Network 509. In this case an asynchronous call is made by sales system 504. Subsequently, each item is checked for the presence of a unique identifier 506, if an item is found without a unique identifier, a new unique identifier 516 is generated and assigned to this item. A plurality of sub-requests 530 for plurality of partners' systems is then generated where each sub-request is assigned to an internal or external system by means of the set of rules 518 which allow to configure the sequence functions are called. Complex dependencies have access using Condition Technology 527. Then the Fulfilment Coordination Engine calls asynchronously partner's functions according to Customizing 525 via the control program 510 and the sub-requests are processed at the partner side. The resulting sub-responses which are sent by the partner systems back to the Fulfilment Coordination Engine have the same unique identifiers as the sub-requests sent originally.

Thus, when FCE receives asynchronously the sub-responses 532, those sub-responses are stored in the database tables 511 and can be associated on the base of the matched unique identifiers with the original sub-requests, so that the central data processing can be continued when all the sub-responses of the asynchronous function calls are available. In order to determine if all sub-responses are collected, a control program 510 performs a query each time a sub-response comes back from the partner system, in order to retrieve all relevant sub-responses stored so far in the database.

If the number of the stored responses is determined to be insufficient, the received sub-response is then stored in the database until all the sub-responses are collected. When on the other hand, the database query determines all the received sub-responses to be sufficient, then the final response 534 is sent to the customer's data processing system. The response can be displayed utilizing a sales system interface 507. However, it is also possible that the result is not displayed at all, it depends on the calling system/application which of the two options occurs. In any case, all the details of the partner search or/and availability check are hidden from the calling system/application.

SCM scheduling module 528 can be called by the Fulfilment Coordination Engine system to determine the dates which are transferred to the partners' functions based on the dates received from the customer. Also, it is further used to determine the dates to be returned to the customer based on the dates received in the sub-responses from the partners' systems.

In case of asynchronous communication, also the workflow 529 can be used together with the Fulfilment Coordination Engine. In this case sub-responses from partner's functions are received via the workflow which is started when asynchronous calls of the partner's functions are triggered.

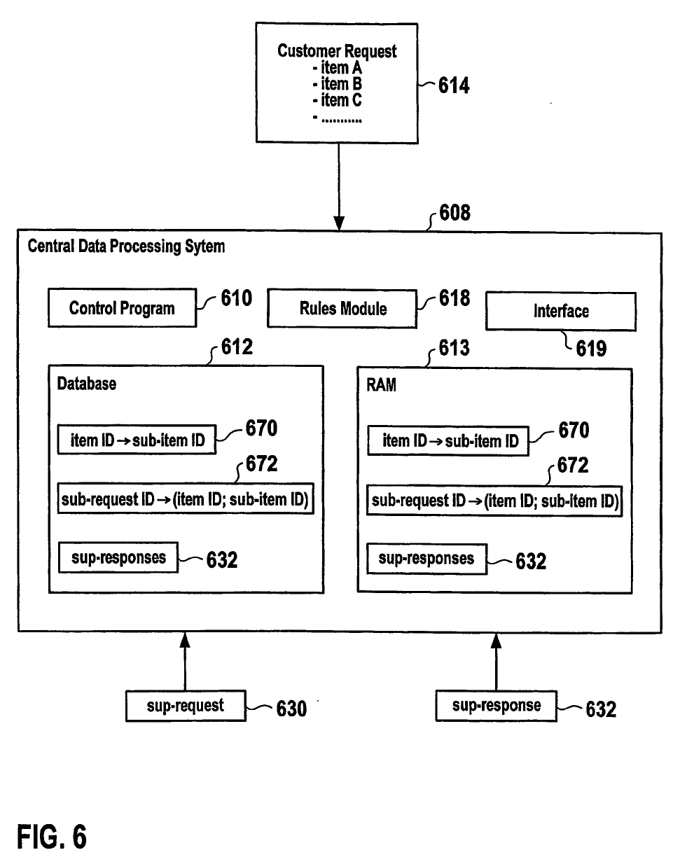

FIG. 6 shows a block diagram of an alternative embodiment of the central data processing system. Elements of the embodiment of FIG. 6 that correspond to elements of the embodiments of FIG. 1, 4 or 5 are designated by like reference numerals.

The central data processing system 608 has a control program 610 that is executed by a processor of the central data processing system 608 (not shown in the drawing). The control program 610 controls operation of the central data processing system 608. Further, the central data processing system 608 has a rules module 618 for storage of rules that are used for selecting the asynchronous or synchronous communication mode and for splitting a request 614 into sub-requests 630. The central data processing system 608 has one or more interfaces 619, such as TCP/IP capable interfaces, for receiving the customer request 614, sending a response to the customer request back to the requestor and for communicating with the partner computer systems (not shown in FIG. 6) that are coupled to the central data processing system 608.

The central data processing system 608 has a non-volatile storage medium, such as a magnetic disc, for storing a database 612. In addition the central data processing system 608 has a main memory 613, i.e. a random access memory. Depending on the selected communication mode sub-responses received from the partner computer systems are stored in the database 612 or in the main memory 613. After all sub-responses for a request 614 have been received a respective response that combines the sub-responses is generated and sent back to the requestor from the central data processing system 608.

In operation the central data processing system 608 receives the request 614. In the example considered here, the request 614 carries a number of items A, B, C . . . that identify respective products or services that the customer considers to purchase or order. When the central data processing system 608 receives the request 614 the control program 610 is invoked and applies the rules of rules module 618 to the customer request in order to select the synchronous or asynchronous communication mode and in order to split the request 614 into sub-requests, if necessary. In addition, individual items contained in the request 614 can be split into sub-items, if required by the rules. Each item, sub-item and sub-request get assigned a unique identifier (ID) such as a globally unique identifier.

If the synchronous communication mode is selected, data 670 is stored in the main memory 613. The data 670 describes the mapping of item IDs to sub-item IDs. Likewise data 672 that describes the mapping of sub-requests to item and sub-item IDs is stored in the main memory 613.

When one of the sub-requests 630 is sent from the central data processing system 608 to the respective partner computer system, the central data processing system 608 receives a sub-response 632. Both the sub-request 630 and the sub-response 632 carry the same sub-request ID that enables the central data processing system 608 to interpret sub-response 632 as belonging to the sub-request 630. In the synchronous communication mode the sub-responses 632 that are received from the partner computer systems are stored in the main memory 613.

In the asynchronous communication mode the data 670 and data 672 is stored on a non-volatile storage medium. The sub-responses 632 are stored in the database 612 using the respecting sub-request IDs as database keys.

In the synchronous communication mode the central data processing system 608 sends one of the sub-requests 630 of request 614 at a time to the respective partner computer system. The central data processing system 608 waits for the sub-response 632 until the next sub-request 630 is sent out. When all sub-responses 632 have been received and temporarily stored in the main memory 613 the sub-responses 632 are combined by the control program 610 in order generate a response that is sent back to the requestor by means of interface 619.

In the asynchronous communication mode a plurality of the sub-requests 630 can be sent out to the respective partner computer systems in parallel. Each time a sub-response 632 is received from one of the partner computer systems the status of the database 612 is checked for completeness of the sub-responses 632. This can be done by querying the database 612 using the sub-request IDs of the sub-responses as a query criterion. If all sub-responses 632 for a given request 614 except the newly received sub-response 632 are already stored in the database 612 the sub-responses 632 are read from the database 612 into the main memory 613 for generating the response to the requester.

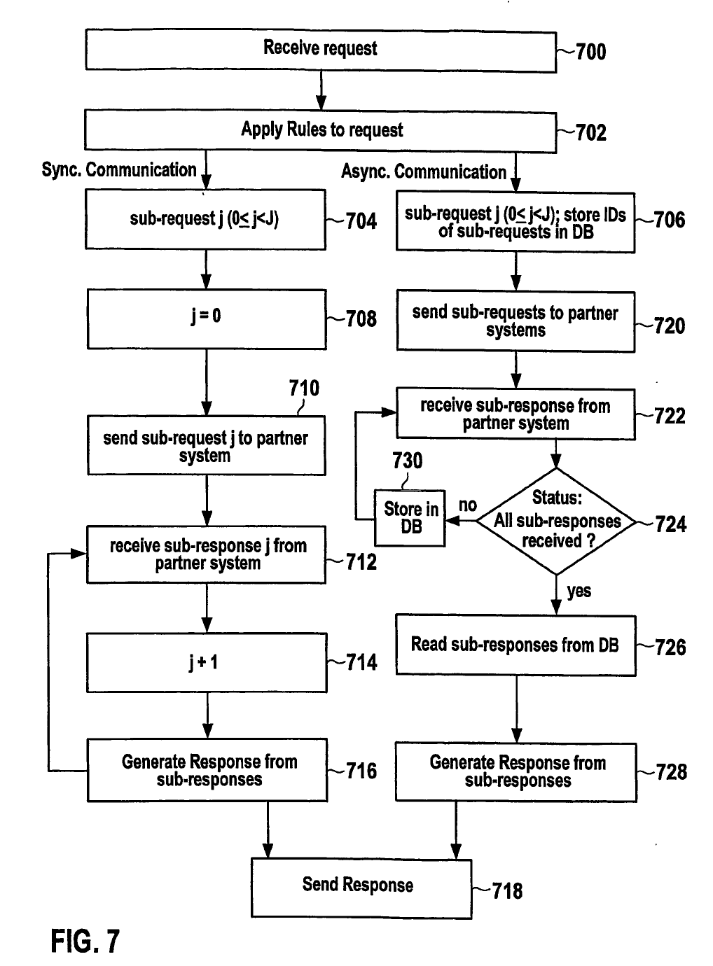

FIG. 7 shows a corresponding flowchart.

In step 700 a customer request is received by the central data processing system. In step 702 a set of rules is applied to the request in order to determine whether synchronous or asynchronous communication is to be used. In addition the request is split up into a number J of sub-requests j if required (step 704 in the case of synchronous communication and step 706 in the step of asynchronous communication).

In the synchronous communication mode the index j is initialized in step 708. In step 710 the first sub-request j is sent from the central data processing system to the respective partner computer system. The central data processing system is in a wait state until it receives the sub-response j from the partner computer system in step 712. The sub-response j is stored in the random access memory of the central data processing system. In step 714 the index j is incremented and the control goes back to step 710.

After all sub-responses j for the request have been received the control goes to step 716 where the sub-responses that are temporarily stored in the random access memory are combined in order to generate the response to the request received in step 700 (step 716). The response is sent back to the requestor in step 718.

If the asynchronous communication mode has been selected in step 702 the unique identifiers that are assigned to the sub-requests are used as keys for storage of the sub-requests in the database (step 706). In step 720 the sub-requests are sent to the partner computer systems. This can be done in parallel. In step 722 a sub-response is received from one of the partner computer systems. The sub-response carries the same unique ID as its respective sub-request. This enables the central data processing system to identify the sub-response as belonging to one of the sub-requests that have been sent out in step 720. In step 724 the central data processing system checks the status of the database. If all sub-responses have already been received the previously received sub-responses are read from the database in step 726 and the response is generated in step 728 before it is sent out in step 718.

If the contrary is the case, the sub-response received in step 722 is stored in the database using its unique ID as a key (step 730). From there the control goes back to step 722. The status check in step 724 is performed each time a sub-response is received from one of the partner computer systems in order to determine, whether all sub-responses have already been received or not.

Although the present invention has been described in detail with reference to certain preferred versions thereof, other versions are possible. The detailed descriptions of the synchronous and asynchronous communication in FIGS. 4 and 5 were presented as unmixed systems for the sake of the clarity.

Nevertheless, the present invention is also designed for the many versions of mixed asynchronous and synchronous communication. For example, the calling system/application can send a synchronous call, then the Fulfilment Coordination Engine can call some of the partner systems using synchronous communication and other systems can be called asynchronously. Also, other variations of mixed systems are possible. Therefore the spirit and scope of the appended claims should not be limited to the preferred versions herein.

### LIST OF REFERENCE NUMERALS

100 customer
102 internet
104 sales system
106 unique identifier
108 central data processing system
110 control program
112 database
114 request
116 unique identifier
118 rules module
120 purchasing system
122 manufacturing system
124 planning system
126 other internal or external system
326 document of the central data processing system
328 document header
330 document items
332 document schedule lines
334 sales order
335 sales order header
336 sales order items
337 sales order schedule lines
344 purchase order
345 purchase order header
346 purchase order items
347 purchase order schedule lines
350 base document
352 item
354 schedule line
356 successor document
358 result
400 customer
402 internet
404 sales system
406 unique Identifier
407 interface
408 Fulfilment Coordination Engine
409 network
410 control program
411 memory used for storage of sub-responses
412 database used for storage of the unique identifiers
413 Synchronous Remote Function Call
414 request
415 interface
416 unique identifier
417 functions
418 rules module
420 purchasing system
422 manufacturing system
424 planning system
425 customizing and core data module
426 other internal or external system
427 Condition Technology module
428 scheduling module
429 workflow module
430 sub-request
432 sub-response
434 response
500 customer
502 internet
504 sales system
506 unique Identifier
507 interface
508 Fulfilment Coordination Engine
509 network
510 control program
511 database used for storage of sub-responses
512 database used for storage of the unique identifiers
513 XI Routing
514 request
515 interface
516 unique identifier
517 functions
518 rules module
520 purchasing system
522 manufacturing system
524 planning system
525 customizing and core data module
526 other internal or external system
527 Condition Technology module
528 scheduling module
529 workflow module
530 sub-request
532 sub-response
534 response
608 central data processing system
610 control program
612 database
613 main memory
614 request
618 rules module
619 interface
670 data
672 data

1. A data processing method for a customer request comprising:
a) receiving a request for at least one item at a central data processing system;
b) generating a plurality of sub-requests for a plurality of partner systems where each sub-request is assigned to an internal or external system by means of rules;
c) generating a separate unique identifier for each of the sub-requests;
d) storing the unique identifiers being assigned to the sub-requests, in a retrievable medium;
e) sending the sub-requests with the unique identifiers to partner systems;
f) receiving back sub-responses at the central data processing system, said sub-responses having unique identifiers in association with the unique identifiers of the request;
g) generating a response based on association of the sub-responses with the original item;
h) sending the response back to the customer data processing system.

2. The method of claim 1, wherein said sending of the sub-requests to partner systems further comprises at least one of:
sending a sub-request for a partner search or a partner availability check at item level or:
determining at least one business system or an availability check for this system at item level.

3. The method of claim 2, wherein performing of the partner search is done with the use of functions.

4. The method of claim 3, wherein the functions comprise standard functions, as well as functions of customers and partners.

5. The method of claim 2, wherein the partner system which received the request for availability check temporarily reserves a requested resource that has been identified as available.

6. The method of claim 5, wherein the partner system deletes the reservation for the requested resources unless the central data processing system sends a message if no acceptance is received from the customer within the predetermined time interval.

7. The method of claim 1, wherein the request comprises a plurality of items, the method comprising:
performing b) to g) for each item.

8. The method of claim 7, wherein the request comprising the plurality of items is processed in a looping mode.

9. The method of claim 1, wherein the request for the at least one item has a structure of an order-like document that comprises:
a header section;
at least one item;
at least one schedule line per item comprising information regarding requested by the customer a delivery date and a quantity.

10. The method of claim 1, wherein b) includes criteria defined by the customer.

11. The method of claim 1, further comprising the following operations conducted prior to h):
comparing at least one sub-response to the preferred choice specified by a customer;
selecting a preferred choice from the group consisting of the at least one sub-response.

12. The method of claim 11, wherein the act of selecting the preferred choice is based on the customer's preferences.

13. The method of claim 11, wherein asynchronous communication means are used and the sub-responses are aggregated in the database until all sub-responses have been received.

14. A central data processing system for processing of the customer request comprising:
a) means for receiving the request for at least one item at a central data processing system;
b) means for generating a plurality of sub-requests for plurality of partners where each sub-request is assigned to an internal or external system by means of the rules;
c) means for generating a separate unique identifier for each of the sub-requests;
d) means for storing the unique identifiers being assigned to the sub-requests, in a retrievable medium;
e) means for sending the sub-requests with the unique identifiers to partner systems;
f) means for receiving back sub-responses at the central data processing system, said sub-responses having unique identifiers in association with the unique identifiers of the request;
g) means for generating a response based on association of the sub-responses with the original item;
h) means for sending the response back to the customer data processing system.

15. The central data processing system of claim 14, wherein a central data processing system further comprises interfaces for communication between a sales system, the purchasing system, the manufacturing system, the planning system and other internal or external systems.

16. The system of claim 14, further comprising asynchronous communication means to use database tables for storage of the sub-responses.

17. The system of claim 16, wherein the means of generating a response based on association of the sub-responses with the original item and sending the response back to the customer data processing system, in case of the asynchronous communication, are applied only when all the requested sub-responses are collected in the database.

18. The system of claim 17, wherein the asynchronous communication means are to execute a query to determine if all necessary sub-responses have been collected.

19. A computer-readable storage medium holding code to:
a) receive a request for at least one item at a central data processing system;
b) generate a plurality of sub-requests for plurality of partners where each sub-request is assigned to an internal or external system by means of rules;
c) generate a separate unique identifier for each of the sub-requests;
d) store the unique identifiers being assigned to the sub-requests, in a retrievable medium;
e) send the sub-requests with the unique identifiers to partner systems;
f) receive back sub-responses at the central data processing system, said sub-responses having unique identifiers in association with the unique identifiers of the request;
g) generate a response based on association of the sub-responses with the original item;
h) send the response back to the customer data processing system.

20. A data processing system for processing a request, the data processing system comprising:
means for selecting an asynchronous or a synchronous communication mode for communication with partner computer systems,
means for splitting the request into a set of sub-requests,
synchronous communication means being adapted to send a first one of the sub-requests of the set of sub-requests to one of the partner computer systems, wait for the respective sub-response from the one of the partner computer systems and send a second one of the sub-requests of the set of sub-requests to one of the partner computer systems after the sub-response has been received, wherein the sub-responses are stored in a random access memory,
asynchronous communication means being adapted to send the sub-requests in parallel to the partner computer systems, store respective sub-responses of the partner computer systems in a database on a non-volatile storage device, means for combining the sub-responses to generate a response to the request,
means for sending the response.

21. The data processing system of claim 20, wherein the means for selecting the asynchronous or synchronous communication mode comprises a set of rules to be applied on the request.

22. The data processing system of claim 21, wherein the means for splitting the request into a set of sub-requests uses the set of rules for the splitting operation.

23. The data processing system of claims 20, wherein the asynchronous communication means is to check the database for completeness for each incoming sub-response.

24. The data processing system of claim 23, wherein the asynchronous communication means is to perform the check of the database by performing a database query using the sub-request and sub-response identifiers as keys.

25. A method for processing a request comprising:
selecting an asynchronous or synchronous communication mode for communication with partner computer systems,
splitting the request into a set of sub-requests,
if the synchronous communication mode has been selected: sending a first one of the sub-requests of the set to one of the partner computer systems, waiting for the respective sub-response from the one of the partner computer systems, sending a second one of the sub-requests of the set to a second one of the partner computer systems after the sub-response from the first one of the partner computer systems has been received, wherein the sub-responses are stored in a random access memory,
if the asynchronous communication mode has been selected: sending a plurality of the sub-requests in parallel to partner computer systems, storing respective sub-responses of the partner computer systems in a database on a non-volatile storage device,
combining the sub-responses to generate a response to the request,
sending the response to the requestor.

26. The data processing method of claim 25, wherein a set of rules is used for selecting the asynchronous or the synchronous communication mode and for splitting the request into a set of sub-requests.

27. The data processing methods of claim 25, further comprising checking the asynchronous communication mode, checking the database for completeness with each incoming sub-response.

28. The data processing method of claim 27, wherein a database query is performed for each incoming sub-response, in order to determine whether all sub-responses for the request have been received.

29. (canceled)
